(19) United States
(12) Patent Application Publication
(10) Pub. No.: US 2004/0008234 A1
(43) Pub. Date: Jan. 15, 2004

(54) Digital printing method with reduced visible banding

(75) Inventors: Barbara L. Grady, Webster, NY (US); Charles D. DeBoer, Palmyra, NY (US); Diane C. Freeman, Pittsford, NY (US); Edward A. Hauschild, Pittsford, NY (US); Jennifer C. Stanek, Fairport, NY (US); Simon D. Yandila, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/191,582

(22) Filed: Jul. 9, 2002

(51) Int. Cl. B41J 2/015

(52) U.S. Cl. 347/20

(57) ABSTRACT

A digital printing method for printing photographic quality images employs a printhead having a plurality of recording elements at least some of which recording elements are arranged in a line. A recording sheet is moved relative to the printhead to form an image on the recording sheet. The recording sheet has parallel spaced side edges. A page of image data to be printed on the recording sheet is provided that represents an image having top, bottom and side edges to establish a substantially rectangular image. The image is formed on the recording sheet through lines or bands of recording sequences that form the image so that the top side edge of the image is formed at an oblique angle to the side edges of the recording sheet wherein the oblique angle is between 15 degrees and 75 degrees. Alternatively, the top side edge of the image is formed perpendicular to the side edges of the recording sheet through formation of the image by swaths of recording sequences that are oblique to the top edge of the image. When the image is correctly viewed by an observer with the top image thereof parallel to the horizon, any banding artifacts which would tend to be formed by the digital printer at the oblique angle to the top edge are substantially not visible to the observer.

### FIELD OF THE INVENTION

The present invention relates in general to digital reproduction methods wherein photographic quality prints may be made using an inkjet printer preferably or other digital printer as will be described herein.

### BACKGROUND OF THE INVENTION

In the production of high-quality photographic images using inkjet printing, it is known that an inkjet printhead may be used to record the image. There are basically two types of inkjet printheads that are used. One of these printheads is known as a full-width printhead wherein a recording sheet may be advanced relative to the printhead in a sub-scan direction and one or more lines of images are recorded substantially simultaneously. The second type of printhead is a scanning type of printhead wherein the printhead is supported on a carriage and moves in a transverse or main scan direction relative to advancement of the recording sheet. Typically, the full-width printhead has a line of recording elements such as nozzles arranged in a main scan direction at a resolution of at least about 300 dpi in order to provide for photographic quality imaging. The scanning type of printhead has the recording elements such as nozzles arranged in the sub-scan direction in one or more parallel rows and in certain printers the nozzles and the different rows may be offset from one another to increase resolution of the printhead. The scanning type of printhead has the advantage of making multiple passes over a swath or limited area of the recording sheet and can place ink at adjacent pixels through different passes to limit coalescence of adjacent ink drops.

The individual recording elements of the printhead, i.e. inkjet nozzles, may print either binary or gray scale pixels. The term binary pixels implies either pixels recorded or not recorded at a pixel's location on the recording sheet. All recorded pixels are of the same size or density. The term gray scale pixels implies that individual pixels may vary in size or density on the recording sheet. As is well known, there is a relationship between numbers of gray levels and resolution of the recorded pixels that result in what an average observer might consider to be photographic quality. However, the term photographic quality is generally understood to mean the quality equivalent to that of the typical average snap shot using a camera and photographic processing of the exposed photographic film onto photographic paper. Typically, photographic quality using a printer that records electronically requires that the resolution of the image be recorded at least 300 dpi in both a main-scanning direction and a sub-scanning direction, it being known that the resolution in the main scanning direction need not match the resolution in the sub-scanning direction. In attempts to provide for quality of prints from inkjet printers that are equivalent to that of those produced from camera produced snap shots, a problem arises in that quality may suffer from a problem known as “banding.” The banding problem arises due to consistent artifacts being provided at predetermined locations which the eye is susceptible in detecting.

An object of the invention is directed to reducing the apparent visibility of the banding errors that can arise in inkjet printing and other printing methods and thereby providing for photographic quality prints that are more appealing to the ordinary observer due to the reduction in visible banding apparent from viewing of the print.

### SUMMARY OF THE INVENTION

In accordance with a first aspect of the invention there is provided a method of printing an image of photographic quality comprising providing a printhead having a plurality of recording elements at least some of which recording elements are arranged in a line; moving a recording sheet relative to the printhead to form an image on the recording sheet, the recording sheet having parallel spaced side edges; providing a page of image data to be printed on the recording sheet, the image data being suited for forming a photographic quality print, the image data representing an image having top, bottom and sides edges,to establish a substantially rectangular image; and forming the image on the recording sheet through lines or bands of recording sequences that form the image so that the top side edge of the image is formed at an oblique angle to the side edges of the recording sheet, wherein the oblique angle is between 15 degrees and 75 degrees.

In accordance with a second aspect of the invention, there is provided a method of printing an image of photographic quality comprising providing a recording sheet having top, bottom and side edges and being in the form of a rectangle, the sheet including a rectangular image recording area, the rectangular image recording area including a top, bottom and side edges of the image recording area, the top edge of the image recording area being at an oblique angle to the top edge of the recording sheet, the oblique angle being between 15 degrees and 75 degrees; forming an image in the rectangular image recording area by using a recording element or elements that move relative to the top edge of the area in a direction parallel to the top edge of the image recording area to record pixels of the image in lines or swaths of the image; and separating the recorded image on the rectangular image recording area from the recording sheet so that the recorded image may be viewed with the top edge held horizontal.

In accordance with a third aspect of the invention, there is provided a method of printing an image of photographic quality comprising providing a printhead having a plurality of recording elements at least some of which recording elements are arranged in a line; moving a recording member relative to the printhead to record an image on the recording member, the recording member having parallel side edges; providing a page of image data to be recorded on the recording member, the image data being suited for forming a photographic quality print, the image data representing an image having top, bottom and sides edges to establish a substantially rectangular image; outputting image data sequentially in lines of image data to the printhead in the form of image data representing pixels of an image representing rotation of the entire image that is oblique to the parallel side edges of the recording member; and recording the image on the recording member through lines of recording sequences that form the image so that the top side edge of the image is formed at an oblique angle to the parallel side edges of the recording member, wherein the oblique angle is between 15 degrees and 75 degrees to the parallel side edges.

In accordance with a fourth aspect of the invention, there is provided a method of printing an image of photographic quality comprising providing a printhead having a plurality of recording elements at least some of which recording elements are arranged in a line; moving a recording member relative to the printhead to record an image on the recording member, the recording member having parallel side edges; providing a page of image data to be recorded on the recording member, the image data being suited for forming a photographic quality print, the image data representing an image having top, bottom and sides edges to establish a substantially rectangular image; outputting image data sequentially in lines of image data to the recording elements of the printhead in the form of image data representing pixel rows of the image which rows are oblique to the parallel side edges of the recording member; and recording the image on the recording member so that at least some of the recording elements each produce portions of the image through plural lines or swaths of recording sequences so that the printhead sequentially records the image at an oblique angle to the parallel side edges of the recording member, wherein the oblique angle is between 15 degrees and 75 degrees to the parallel side edges.

### BRIEF DESCRIPTION OF THE DRAWINGS

The above and other objects, features and advantages of the present invention will become more apparent upon a reading of the following detailed description of the preferred embodiments when read in association with the accompanying drawings, which are given by way of the illustration only and thus are not limiting of the present invention. In the drawings, like reference numerals designate like corresponding parts throughout the several views, and wherein:

FIG. 1 is an illustration of a print formed in accordance with the invention.

FIG. 2 is an illustration of a first embodiment of an inkjet printer apparatus that may be used to form prints such as the print illustrated in FIG. 1 in accordance with the invention.

FIG. 3 is an illustration of a second embodiment of an inkjet printer apparatus that may be used to form prints in accordance with the invention.

FIG. 4 is an illustration of one example of a thermal printer apparatus that may be used in accordance with the invention to form a print such as that illustrated in FIG. 1.

FIG. 5 is a schematic of a system that may be used to form the prints in accordance with the invention herein.

FIG. 6 is a block diagram in more detail of the system of FIG. 5.

### DETAILED DESCRIPTION OF THE PREFERRED EMBODIMENTS

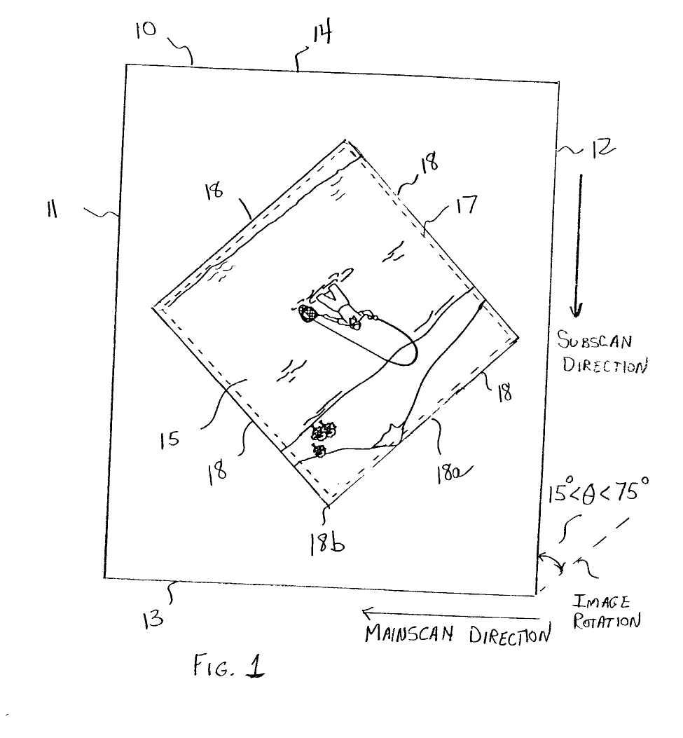

With reference now to FIG. 1, there is illustrated a rectangular receiver sheet 10 having parallel side edges 11,12 and a leading edge 13 and a trailing edge 14. An image 15 has been electronically printed on the receiver sheet 10 by an electronic digital printer apparatus as will be described below. The printed image is of photographic quality, which implies equivalence to what the ordinary observer would consider to be equivalent to a color snapshot taken with a camera and developed in accordance with usual photographic quality of a commercial photofinisher. It will be noted that a top edge 18a of the printed image is at a relatively gross angle with respect to the leading edge 13 of the receiver sheet. In accordance with the invention, this gross angle θ is greater than 15 degrees and less than 75 degrees. It will be further noted that within the border of the image 18 is a dashed closed figure or item 17, preferably rectangular, that represents micro-perforations or micro-slits which allows for easy separation of the printed image 15 from the receiver sheet 10. In order to provide for borderless prints, the example of FIG. 1 provides that the printed image extends beyond the border of the removable print to provide for what is known as known as “borderless prints.” In this regard, reference is made to U.S. Pat. No. 4,289,840 (Sylvester) and U.S. Pat. No. 4,765,654 (Nokamura).

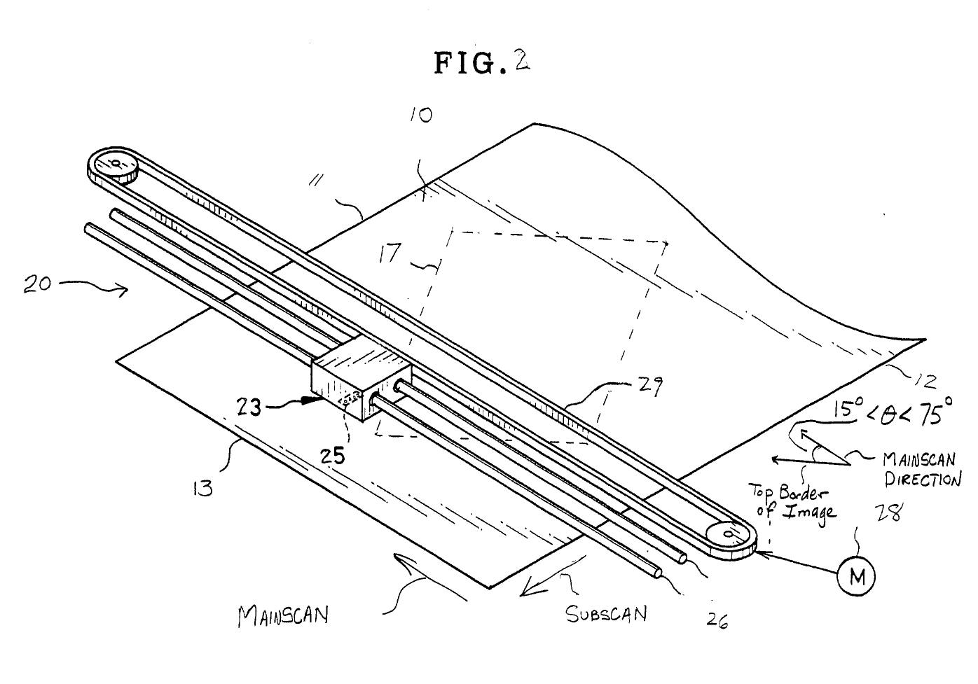

In FIG. 1 and with reference also to FIG. 2, it will be also noted that the printing of the printed image 15 has been made by a printer which prints the image in a main scan direction that is parallel to the leading edge 13 of the receiver sheet and then moves the receiver sheet 10 in a sub-scan direction which is parallel to sides edges 11, 12 of the receiver or recording sheet. With regard to the printed image 15, it will be also noted that in accordance with the invention that there is little difference between which edge is termed the top edge, however, it is important that the printed image be substantially rectangular (an image that has slightly rounded corners, as is well known for completed photographic prints, are considered to be substantially rectangular).

In accordance with a first embodiment of the invention, an inkjet printer apparatus 20 is illustrated in FIG. 2 in the process of initiating printing of the printed image 15 shown in FIG. 1 on a receiver sheet 10 having a rectangular area defined by a set of micro-slits or micro-perforations 17. It will be understood, of course, that the slits may be continuous to form one enclosed rectangular area defined by continuous slits as illustrated for example in the above patent of Sylvester. The inkjet printer apparatus of FIG. 2 is of conventional structure and includes a printhead 23 that has a row of recording elements such as inkjet nozzles 25 arranged perpendicular to the main scan direction. Typically, for a color inkjet printer, there will be plural rows of recording elements, at least one row for printing a different color of ink. For example, there may be one or more parallel rows of nozzles for printing with cyan colored ink, one or more parallel rows of inkjet nozzles for printing with magenta colored ink and one or more parallel rows of inkjet nozzles for printing with yellow colored ink. Additionally, it may be desirable to also provide one or more rows of inkjet nozzles for printing with black colored ink and additional rows of nozzles for printing specific selected colors. The parallel rows of nozzles will be arranged perpendicular to the main scanning direction in the example of the apparatus of FIG. 2. As is well known, various nozzles are connected to a suitable supply of ink for that color, not shown, and during a printing operation signals are provided to the printhead 23 in accordance with the image to be printed to selectively enable the various nozzles at appropriate times as is well known to record an image on the receiver sheet 10 by depositing ink at selected pixel locations. During this recording operation, the printhead 23 is moved along rails 26 transversely across the width of the receiver sheet in a direction parallel to the leading edge 13 of the receiver sheet. The printhead may be driven by a belt, such as a timing belt 29, that is connected to the printhead, and the belt being driven by motor 28. Alternatively, the printhead may be connected to a rail that is a rotating screw that advances the printhead in a similar manner for back and forth movement across the total width of the receiver sheet 10 between side edges 11 and 12. As the printhead 23 traverses across the receiver sheet 10 in a back and forth motion, swaths of the image are printed with each swath representing a segment of the image. A problem with printing of an image with swaths is that banding tends to occur between adjacent swaths and can be visible and cause a distraction from appreciation of the image. The inventors have found that by printing the image so that a top edge thereof is at least 15 degrees but less than 75 degrees of any such banding that the banding does not detract from appreciation of the image. Generally, the advantages of the invention are realized wherein the top edge 18a of the printed image 15, which would tend to be oriented horizontally when viewed by the viewer of the image, is printed by a printer whose main scan direction of printing is at an angle of at least 15 degrees but less than 75 degrees to the top edge of the printed image, more preferably at least 30 degrees but less than 60 degrees to the top edge of the printed image, and still more preferably at an angle of 45 degrees to the printed image. In lieu of a swath printer, the printhead may be a full width printer and extend completely across the full width of the receiver sheet 10 so that its recording elements extend in at least one row for each color at least between the side margins 11 and 12 of the recording sheet or of the largest width dimension to be printed. The inkjet printheads may be of the continuous inkjet printing type, the drop on demand inkjet type including thermal and piezoelectric.

In the printer of FIG. 2, it is assumed that orientation of the parallel side edges 11 and 12 are substantially square with the main scan direction. In a printer 20 feeding rollers, not shown, are provided for advancing the sheet in a sub-scan direction which is perpendicular to the main scan direction. The receiver sheet may be a discrete receiver sheet or a continuous receiver sheet that is slit after printing of each image to form the leading edge of the receiver sheet. Thus, a leading edge of the receiver sheet typically would occur parallel to the main scan direction and the printed image 15 is removed by separating the perforated rectangular image portion from the receiver sheet 10. In the printer of FIG. 2, since the image is typically output to a printer in swaths that are parallel to the leading edge of the receiver sheet it is necessary for an image rotation to be provided for in the image processing to accommodate the difference in angle between the top edge of the image and the leading edge of the receiver sheet. Rotation of image data to various selected angles is a skill well within that of the state of the art. However, such has not been done in the context of the invention described herein. Although the leading corner 18b of the image is shown spaced from the leading edge 13 of the receiver sheet 10 this corner may be at or coincident with the leading edge 13 to facilitate timing of commencing recording of the image.

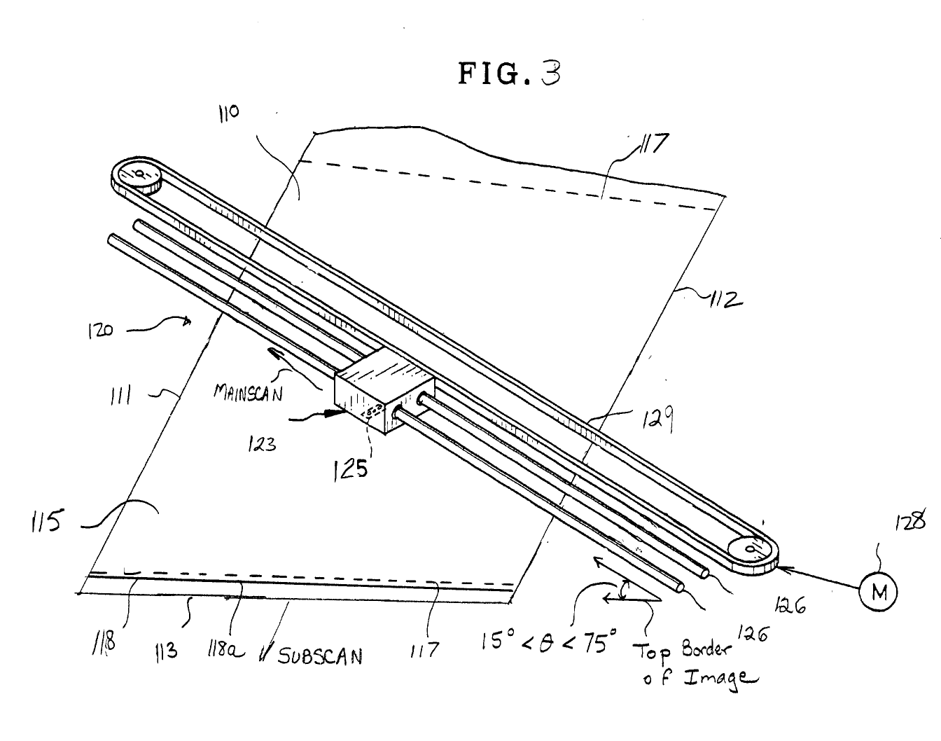

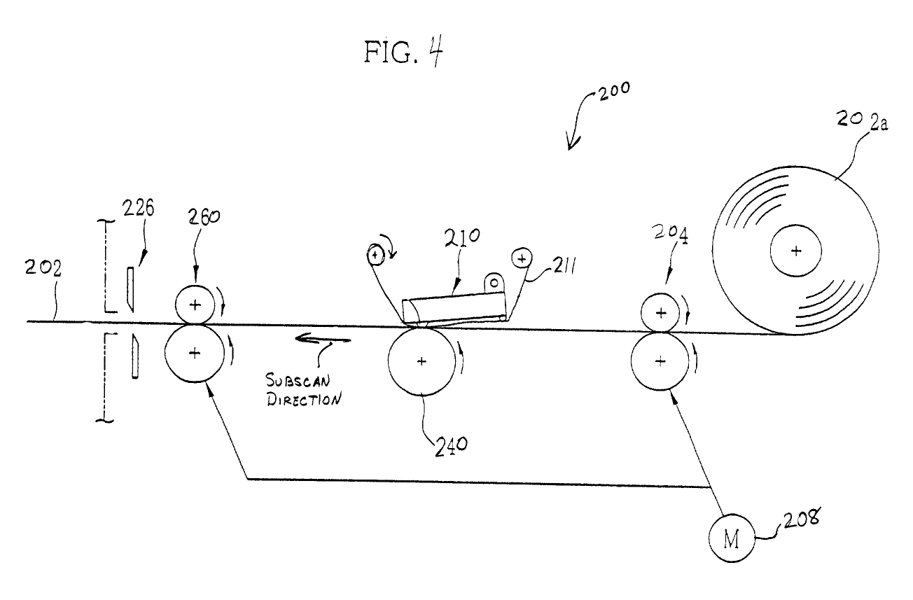

In order to facilitate creation of prints without the need to have a rectangular area defined by micro-perforations or micro-slits a preferred second embodiment is illustrated in FIG. 3 wherein corresponding structure or elements to that of FIG. 2 are identified with similar reference numbers with one hundred added thereto. In the embodiment of FIG. 3 the orientation of the rails 126 is skewed relative to the sub scan direction so that the top edge 118a of the border 118 of the rectangular printed image 115 is parallel to the leading edge 113 of the receiver sheet 110. In regard to the use of a continuous receiver sheet, the leading edge of the receiver sheet comprises an edge formed by providing to the receiver sheet a square cut in the direction perpendicular to the feeding direction of the receiver sheet, the feeding direction being the subscan direction illustrated by the arrow in FIG. 3. The rows of inkjet nozzles 125 of inkjet printhead 123 of inkjet printer apparatus 120 are arranged perpendicular to the main scan direction of printing of image segments or swaths as is the case for the embodiment of FIG. 2. A motor 128 is connected to a driver belt or timing belt 129 to which the printhead is attached to advance the printhead in the main scan direction and back. Alternatively, it is known to support the printhead on a threaded rail and rotate the rail to advance the printhead using a screw drive. As is well known, printing may be provided for in the forward and backward directions of movement of the printhead. In the embodiment of FIG. 3, printing of the top edge 118a and the bottom edge of the image may extend beyond micro-perforations or micro-slits 117 formed in the receiver sheet 110. This simplifies manufacture of the receiver sheet by requiring only two straight lines of micro-perforations or micro-slits. The movement of the printhead is such that printing can commence before reaching the side edge 112 and can terminate after reaching the other side edge 111 so that a completely borderless print is printed. In the second embodiment of FIG. 3, the orientation of the rails 126 are at an angle of at least 15 degrees but less than 75 degrees to the leading edge of the receiver sheet 113 or the leading edge of the micro-perforations or micro-slits 117. More preferably, this angle is at least 30 degrees but less than 60 degrees and still more preferably the angle is 45 degrees. The image 115 that is printed is rectangular and the two side edges of the image can correspond with the parallel uniformly spaced side edges 111 and 112 of the receiver sheet to provide for a borderless print. However, the rows of image data that are sent to the printhead are correspondingly adjusted so that the printhead prints a diagonal swath of the image as the printhead traverses in each direction (back and forth) along the rails in a main scan direction of printing. Thus, in this embodiment and in the embodiment of FIG. 2 diagonal or oblique swaths or rows of the image are printed and any banding artifacts caused by such printing of diagonal swaths are on a diagonal or the above stated oblique angle relative to the top edge of the print and have limited visibility when the completed image is correctly oriented for viewing by the ordinary observer such as when it is held in the hands of the ordinary observer for viewing. While in this embodiment, the top edge and the bottom edge of the image are shown as being perpendicular to the subscan direction of movement of the receiver sheet as an alternative the top edge and bottom edge of the image recorded may be parallel to the side edges of the receiver sheet. As in the example of the embodiment of FIG. 4 to be described below, a cutter blade may be provided for forming cuts in a continuous receiver sheet that is advanced in the subscan direction. These cuts as noted above would be perpendicular to the subscan direction.

With reference now to FIG. 4, there is illustrated a thermal printer apparatus 200 that includes a fullwidth thermal printhead 210 that is moved into position for printing and remains stationary when printing and prints by selective actuation of recording elements that are arranged in a single row that is perpendicular to the direction of movement of the receiver sheet in the sub-scan direction indicated by the arrow. On selective actuation of a recording element electric current is provided to the recording element to heat the recording element to transfer dye in a dye donor ribbon 211 to a thermal receiver 202. The receiver may be in a discrete sheet form or payed off a continuous roll 202a. It is preferred to have the receiver sheet contain an image portion defined by the series of micro-perforations or micro-slits 17 which define a substantially rectangular enclosed area that is oriented as is shown in FIG. 2 relative to the sub-scan direction. The receiver sheet 202 may be disposed between a pair of nip rollers 204 and 260 which are driven by motor 208 to advance the receiver sheet past the printhead 210. Alternatively, the pair of rollers 204 need not be driven.

A platen which may be in the form of a platen roller 240 or a plate supports the receiver sheet so that a pressure nip is formed as the dye donor ribbon 211 moves in pressure engagement with the receiver sheet 202. The dye donor ribbon may have a take-up motor or spring for advancing the ribbon through the nip. Where the receiver sheet is a continuous sheet, cutter knives 226 may be provided for severing the sheet along a cut that is parallel to the main scan direction of printing by the recording elements which as noted above is perpendicular to the sub-scan direction. In the example where a single printhead is used, the ribbon may have a series of three or four color patch areas so that each color may be recorded during a color recording cycle. For example, initially the yellow color may be recorded for the entire image, then the printhead is moved away from the printing position to allow the rollers 204 to be operated in a reverse direction to again position the lead edge of the recorded image within the nip. Thereafter, the next color, for example magenta, may be recorded by returning the printhead 210 to the print position wherein the magenta color patch is now presented in the recording nip. This process continues for each of the colors, such as cyan and optionally black, to form a three or four color image. In addition, a clear lamination or colorless layer may also be applied in similar fashion as is well known. In an alternative embodiment, the printer may have separate printheads for each of the colors to be applied wherein the receiver is moved in only one direction and moved from one color print station to the next wherein a different color image is superimposed upon the previous color image and. The thermal printer may also be of the direct recording type wherein no separate dye donor ribbon is provided in and heat is selectively provided by the recording elements directly to the receiver sheet and causes the color image on the receiver sheet to be recorded.

A thermal printer is also contemplated that is a scanning type of printhead that traverses across the image area to print swaths of an image similar to that of movement of the printhead shown in FIGS. 2 and 3 with the swaths being printed along a diagonal of the image.

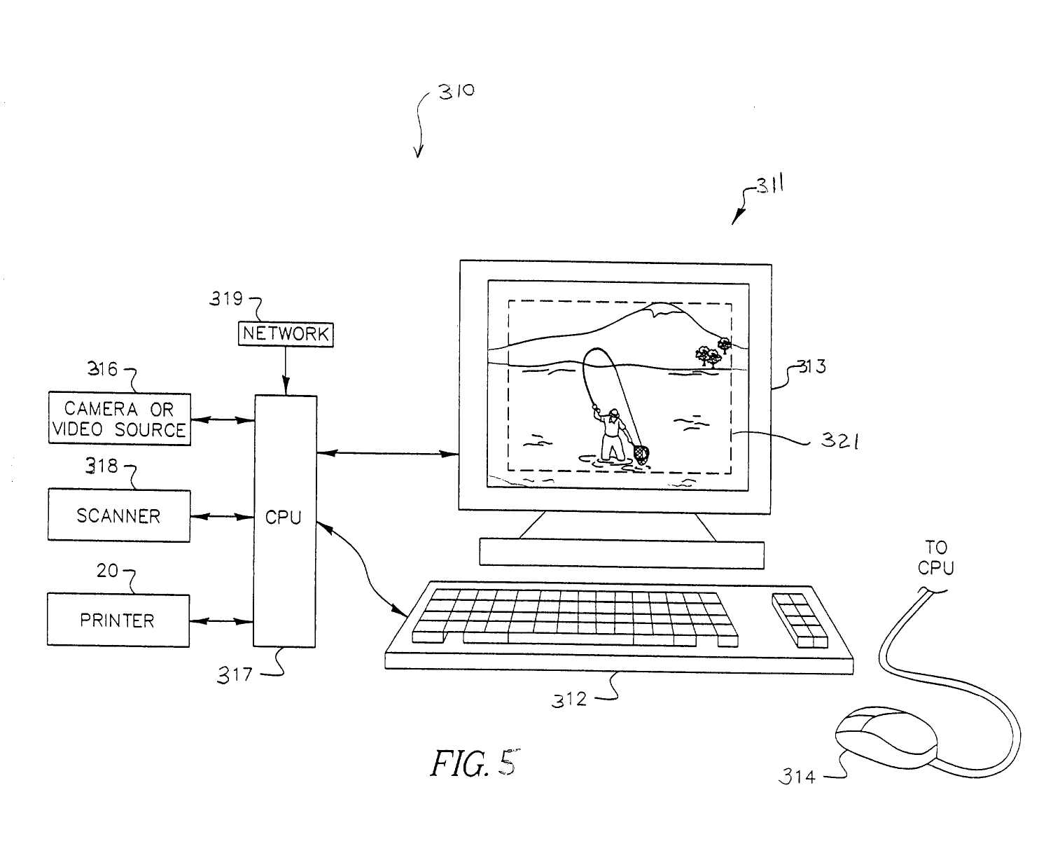

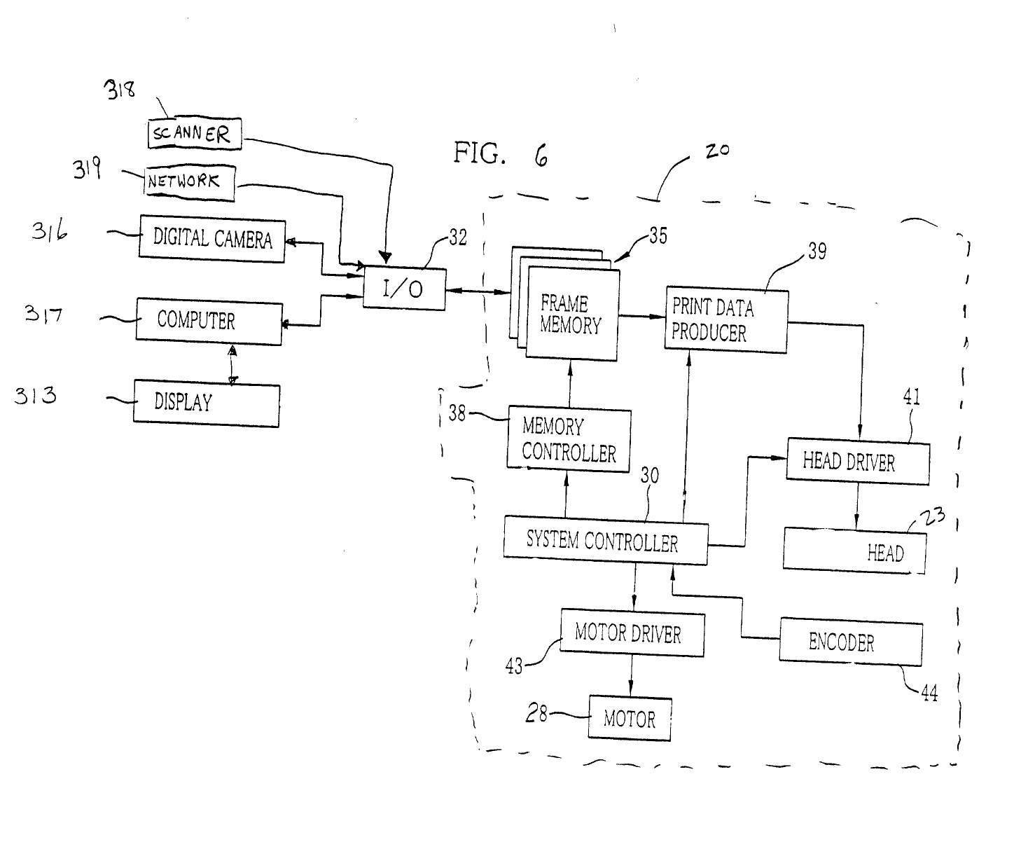

With reference now to FIGS. 5 and 6, there is shown a printer system 310 which includes a computer terminal 311 which an operator may employ to manipulate an image on a display 313, such as a CRT or LED or other type of computer display in the form of a picture to be output for printing by the inkjet printer apparatus 20 of FIG. 2. It will be noted that the other printers described herein may also be used. The source for the picture may be a scanner 318 that for example scans a hard copy of a photograph or a photographic negative. Alternate sources for the picture may be a digital camera or video source 316 or an input of a photographic image that is transmitted via a network input 319. Where the printer includes a receiver sheet that has an image area defined by micro-perforations or micro-slits as described above, the display may feature preferably a software generated outline indicator 321 that identifies the area of the pictorial image that will extend beyond the defined image area and thus will be lost after printing when the defined image area containing the printed image is easily separated from the remainder of the receiver sheet. The operator may thus adjust size or orientation of the image using for example mouse input device 314 that is connected to a central processing unit (CPU) 317. It will be noted that the various devices such as the digital camera or video source 316, scanner 318, inkjet printer apparatus 20, network 319, mouse 314, operator input keyboard 312 and display screen 313 are all connected to the CPU 317.

In addition to being coupled to the CPU 317, there may be direct coupling of various components such as the scanner 318, network 319 and digital camera 316 through an input/output device 32 to the inkjet printer apparatus 20. Control electronics are also associated with the inkjet printer apparatus 20 and include a frame memory 35 that is capable of storing plural color separation images of the photographic quality image to be printed. The frame memory may be large enough to store multiple different images as a buffer. In accordance with the embodiment of FIG. 2, a print data producer 39 processes segments of each color separation image for downloading to a head driver 41. As may be seen in FIG. 1, the image information requires rotation before being downloaded to the head driver 41. Rotation of digital print image data to various angles is well known in the prior art. The head driver 41 provides signals to the printhead 23 for recording the image an example of which is shown in FIG. 1. Movement of the receiver sheet in the sub-scan direction may be in accordance with various drive rollers, as is well known in the art, which rollers provide signals to an encoder 44 that identifies such movement with timed signals provided to a printer system controller 30.

The printer system controller 30 provides control to the overall system components of the printer including a memory controller 38, which controls timed outputs of image data into and out of the frame memory 35. Also controlled by the system controller is the print data producer 39, the head driver 41 and motor driver 43 which controls drive to the motor 28 used to move the printhead 23 in the main scan direction. Other components such as drive motors and rollers for advancing the receiver sheet in the sub-scan direction are also provided but are not shown as they are well known in the printer arts.

The invention is applicable both to the production of prints that are borderless and to those that have borders. The invention is also applicable to inkjet printing of liquids onto a printing plate or plates wherein a liquid is deposited in an imagewise pattern on the plate. Ink is then provided which selectively deposits onto the plate in the imagewise pattern and the ink is then transferred onto a receiver sheet. In such an embodiment the image may be recorded onto the plates at the oblique angle in the ranges described herein (15 degrees to 75 degrees) and then transferred to a receiver sheet so that the top edge of the image when the receiver sheet is viewed parallel to horizon is oblique to the rows of recorded pixels on the receiver sheet formed by each recording element. The plates may be in the form of a drum. Alternatively, the image may be recorded normally onto the plates with the top edge of the image parallel or perpendicular to the parallel side edges of the plates and then the receiver sheet moved at an oblique angle relative to the side edges of the plates so that developed rows of pixels recorded by the recording elements are transferred to the receiver sheet so that a recorded row or rows of pixels on the receiver sheet which represents information recorded by a particular recording element is or are oriented at the oblique angle relative to the top side edge of the transferred image when the image on the receiver sheet is viewed with the top side edge of the image being parallel to the horizon. The invention is further applicable to other forms of digital printing such as electrophotography and electrography wherein a recording member may comprise a drum or web such as a photoconductor or other recording member for supporting an electrostatic image which can then be toned with an electroscopic toner and transferred to a recording sheet as described above for use with plates.

The invention thus provides an improved method of printing an image of photographic quality using a digital printer. In the method of the invention, printing of the image is such that any lines or swaths of recorded information made by a recording element or elements would be recorded at an oblique angle to the top side edge of the recorded image. Therefore, when the image is viewed by an observer and the image is oriented so that the top side edge is parallel to the horizon, any artifacts created by a recording element or in combination with an adjacent recording element would likely be not substantially visible to the observer. In the embodiments of the apparatus and methods described herein, during printing of a swath there is movement in the main scan direction of the printhead during printing of the swath but substantially no relative movement by the recording sheet (or recording member) in the sub-scan direction during such printing of the swath so that a line of pixels printed by any recording element will be substantially at an angle of between 15 degrees and 75 degrees relative to the side edges of the recording sheet or to the top edge of the image. Thus movement of the receiver sheet (or recording member) in such embodiment is preferably intermittent. Where a full-width printhead is employed, it is preferred that all the pixels are simultaneously recorded in a relatively short duration so that, if the recording sheet (or recording member) is moving continuously with the top edge of the image skewed relative to the main scan direction of printing, a line of pixels recorded by any recording element will be recorded at an angle of between 15 degrees and 75 degrees to the top edge of the image. Alternatively, for a full-width printhead a recording sheet (or recording member) may be moved intermittently relative to the printhead in the sub-scan direction between periods for printing rows of pixels.

The invention has been described in detail with particular reference to presently preferred embodiments, but it will be understood that variations and modifications can be effected within the spirit and scope of the invention.

### Parts List

10, 110 receiver sheet

11, 12, 111, 112 sides of respective receiver sheets

13, 113 leading edge

14 trailing edge

15, 115 image

17, 117 micro-perforations or micro-slits

18, 118 border of the image

18a, 118a top edge of the printed image

18b leading corner of the printed image

20, 120 inkjet printer apparatus

23, 123 printhead

25, 125 inkjet nozzles

26, 126 rails

28, 128 motor

29, 129 timing belt

30 printer system controller

32 input/output device

35 frame memory

38 memory controller

39 print data producer

41 head driver

43 motor driver

44 encoder

200 thermal printer apparatus

202 thermal receiver

202a continuous roll of receiver

204 nip rollers

208 motor

210 thermal printhead

211 dye donor ribbon

226 cutter knives

240 platen roller

260 nip rollers

310 printer system

311 computer terminal

312 keyboard

313 display

314 mouse

316 digital camera or video source

317 computer (CPU)

318 scanner

319 network

321 outline indicator

322 input/output device

What is claimed is:

1. A method of printing an image of photographic quality comprising:
providing a printhead having a plurality of recording elements at least some of which recording elements are arranged in a line;
moving a recording sheet relative to the printhead to form an image on the recording sheet, the recording sheet having parallel spaced side edges;
providing a page of image data to be printed on the recording sheet, the image data being suited for forming a photographic quality print, the image data representing an image having top, bottom and sides edges to establish a substantially rectangular image; and
forming the image on the recording sheet through lines or bands of recording sequences that form the image so that the top side edge of the image is formed at an oblique angle to the side edges of the recording sheet, wherein the oblique angle is between 15 degrees and 75 degrees.

2. The method of claim 1 and wherein the parallel spaced side edges of the recording sheet are uniformly spaced a predetermined dimension apart and the printhead is a fullwidth printhead and wherein the printhead is generally stationary during recording as the recording sheet moves past the printhead and the printhead is oriented perpendicular to the parallel side edges of the recording sheet and the printhead simultaneously records a full line of the image data.

3. The method of claim 2 and wherein the recording sheet has lines of micro-perforations or micro-slits to define a substantially rectangular image recording area within which the image is formed on the recording sheet, and wherein the rectangular image recording area may be severed from the remainder of the recording sheet through separation of said micro-perforations or micro-slits, and all the lines of the image recording area defined by the perforations or slits are oblique to the parallel spaced side edges of the recording sheet.

4. The method of claim 1 and wherein the printhead is a swath printing printhead and wherein the printhead moves plural times across the recording sheet to print an image swath or at least a portion of an image swath during each pass of the printhead across the recording sheet, and the printhead prints the image so that the resulting image has a top side edge of the image that is oblique relative to all sides of the recording sheet.

5. The method of claim 4 and wherein the recording sheet has lines of micro-perforations or micro-slits to define a rectangular image recording area within which the image is formed, and wherein the rectangular image area is severed from the remainder of the recording sheet through separation of said micro-perforations or micro-slits, and all the lines of the image recording area defined by the micro-perforations or micro-slits are oblique to the parallel side edges of the recording sheet.

6. The method of claim 5 and wherein the printhead moves in a main scan direction in a direction perpendicular to the parallel side edges of the recording sheet.

7. The method of claim 4 and wherein the printhead moves in a main scan direction in a direction perpendicular to the parallel side edges of the recording sheet.

8. The method of claim 4 and wherein the printhead moves in a main scan direction in a direction oblique to an edge of the recording sheet.

9. The method of claim 1 and wherein the recording sheet has lines of micro-perforations or micro-slits to define a rectangular image recording area within which the image is formed, and wherein the rectangular image recording area may be severed from the remainder of the recording sheet through separation of said micro-perforations or micro-slits, and all the lines of the image recording area defined by the micro-perforations or micro-slits are oblique to the parallel side edges of the recording sheet

10. The method of claim 1 and wherein the printhead records by inkjet printing.

11. The method of claim 1 and wherein the printhead records by thermal printing.

12. A method of printing an image of photographic quality comprising:
providing a recording sheet having top, bottom and side edges and being in the form of a rectangle, the sheet including a rectangular image recording area, the rectangular image recording area including a top, bottom and side edges of the image recording area, the top edge of the image recording area being at an oblique angle to the top edge of the recording sheet, the oblique angle being between 15 degrees and 75 degrees;
forming an image in the rectangular image recording area by using a recording element or elements that move relative to the top edge of the area in a direction parallel to the top edge of the image recording area to record pixels of the image in lines or swaths of the image; and
separating the recorded image on the rectangular image recording area from the recording sheet so that the recorded image may be viewed with the top edge held horizontal.

13. The method of claim 12 and wherein the rectangular area is defined by perforations or slits to facilitate separation of the imaged area from the recording sheet.

14. The method of claim 13 and wherein the recording element or elements forms a part of a printhead array having a plurality of recording elements that are arranged in a line and the printhead array is moved in a direction at an oblique angle to a top edge of the recording sheet, the oblique angle being between 15 degrees and 75 degrees.

15. The method of claim 12 and wherein the recording element or elements forms a part of a printhead array having a plurality of recording elements that are arranged in a line and the printhead array is moved in a direction at an oblique angle to a top edge of the recording sheet, the oblique angle being between 15 degrees and 75 degrees.

16. A recording sheet for use in the method of claim 12, the recording sheet including parallel spaced side edges separated by a predetermined dimension and a substantially rectangular image recording area defined within a rectangular area formed by an enclosed series of lines of micro-perforations or micro-slits, the lines of the perforations or slits all being at an oblique angle to the parallel spaced side edges of the recording sheet, the oblique angle being between 15 degrees and 75 degrees.

17. The recording sheet of claim 16 and wherein the oblique angle is 45 degrees.

18. A method of printing an image of photographic quality comprising:
providing a printhead having a plurality of recording elements at least some of which recording elements are arranged in a line;
moving a recording member relative to the printhead to record an image on the recording member, the recording member having parallel side edges;
providing a page of image data to be recorded on the recording member, the image data being suited for forming a photographic quality print, the image data representing an image having top, bottom and sides edges to establish a substantially rectangular image;
outputting image data sequentially in lines of image data to the printhead in the form of image data representing pixels of an image representing rotation of the entire image that is oblique to the parallel side edges of the recording member; and
recording the image on the recording member through lines of recording sequences that form the image so that the top side edge of the image is formed at an oblique angle to the parallel side edges of the recording member, wherein the oblique angle is between 15 degrees and 75 degrees to the parallel side edges.

19. The method of claim 18 and wherein the parallel side edges are separated by a predetermined spaced dimension and the printhead is a full-width printhead and has a recording dimension at least as great as said predetermined dimension and wherein the printhead is stationary during recording as the recording member moves past the printhead.

20. The method of claim 18 and wherein the recording sheet has lines of micro-perforations or micro-slits to define a rectangular image recording area within which the image is formed, and wherein the rectangular image recording area may be severed from the remainder of the recording sheet through separation of the micro-perforations or micro-slits, and all the lines of the image recording area defined by the micro-perforations or micro-slits are oblique to the side edges of the recording sheet.

21. The method of claim 18 and wherein the recording sheet has lines of micro-perforations or micro-slits to define a rectangular image recording area within which the image is formed, and wherein the rectangular image recording area may be severed from the remainder of the recording sheet through separation of the micro-perforations or micro-slits, and all the lines of the image recording area defined by the micro-perforations or micro-slits are oblique to a top edge of the recording sheet.

22. The method of claim 21 and wherein the printhead prints an image beyond the borders of the micro-perforations or micro-slits in the forming of a borderless print.

23. A method of printing an image of photographic quality comprising:
providing a printhead having a plurality of recording elements at least some of which recording elements are arranged in a line;
moving a recording member relative to the printhead to record an image on the recording member, the recording member having parallel side edges;
providing a page of image data to be recorded on the recording member, the image data being suited for forming a photographic quality print, the image data representing an image having top, bottom and sides edges to establish a substantially rectangular image;
outputting image data sequentially in lines of image data to the recording elements of the printhead in the form of image data representing pixel rows of the image which rows are oblique to the parallel side edges of the recording member; and
recording the image on the recording member so that at least some of the recording elements each produce portions of the image through plural lines or swaths of recording sequences so that the printhead sequentially records the image at an oblique angle to the parallel side edges of the recording member, wherein the oblique angle is between 15 degrees and 75 degrees to the parallel side edges.

24. The method of claim 23 and wherein the recording sheet has lines of micro-perforations or micro-slits to define a rectangular image recording area within which the image is formed, and wherein the rectangular image recording area may be severed from the remainder of the recording sheet through separation of the micro-perforations or micro-slits.

25. The method of claim 24, and wherein two lines of the image recording area defined by the micro-perforations or micro-slits are perpendicular to the side edges of the recording sheet.

26. The method of claim 25 and wherein the printhead prints an image beyond the borders of the micro-perforations or micro-slits in the forming of a borderless print.

27. A method of printing an image of photographic quality comprising:
providing a printhead having a plurality of recording elements at least some of which recording elements are arranged in a line;
moving a recording member relative to the printhead to record an image on the recording member, the recording member having parallel side edges;
providing a page of image data to be recorded on the recording member, the image data being suited for forming a photographic quality print, the image data representing an image having top, bottom and side edges to establish a substantially rectangular image;
outputting image data sequentially in lines of image data to the recording elements of the printhead in the form of image data representing pixel rows of the image;
recording the image on the recording member; and
transferring a recorded image of the substantially rectangular image from the recording member to a receiver sheet so that the image transferred to the receiver sheet is comprised of rows of pixels arranged as plural lines of recorded information that were recorded by respective recording elements so that a pixel row of recorded information recorded by a respective recording element is oriented at an oblique angle to the top side edge of the image on the receiver sheet when the image is viewed by an observer and the image is oriented so that the top side edge is parallel to the horizon, wherein the oblique angle is between 15 degrees and 75 degrees relative to the top side edge.
